(19) United States
(12) Patent Application Publication
(10) Pub. No.: US 2011/0187529 A1
(43) Pub. Date: Aug. 4, 2011

(54) METHOD FOR MONITORING THE QUALITY OF A FUEL COMPRISING ALCOHOL IN A STORAGE TANK

(75) Inventors: Christian Maurer, Hamburg (DE); Wolfgang Schrittenlacher, Hamburg (DE)

(73) Assignee: FAFNIR GMBH, Hamburg (DE)

(21) Appl. No.: 13/119,587

(22) PCT Filed: Jun. 25, 2009
(86) PCT No.: PCT/EP2009/004589

§ 371 Date: Mar. 17, 2011

(30) Foreign Application Priority Data
Sep. 18, 2008 (EP) 08016455.1

(51) Int. Cl. G08B 21/00; G01N 9/36

(52) U.S. Cl. 340/540; 73/30.01

(57) ABSTRACT

The disclosure relates to a method for monitoring the quality of a fuel containing alcohol in a storage tank (1) including a sump area (8), wherein the density of the fluid present in the sump area (8) of the storage tank (1) is measured and compared to prescribed values characterizing the density of a mixed phase comprising water and alcohol as a function of the composition thereof.

Fuels for vehicles are generally stored in underground tanks at filling stations. In order to monitor the stock of fuels, electronic filling level measurement systems have been used for years, and are being used to an increasing extent; these communicate the filling level to an inventory control system of the filling station. The quality control has hitherto primarily been restricted to detecting water which has entered (for example through leaks in the tank dome). Owing to its greater density, this water accumulates at the bottom of the storage tank and can be detected there, conventionally in conjunction with a filling level measurement system which is provided. In the case of capacitive probes the difference in the dielectric constants is used, in the case of ultrasound sensors the speed of sound and in the case of magnetostrictive probes, by means of a separation layer float, the density difference at the interface between the water and fuel.

Fuels are a complex composition of different substances. A fuel mixture must fulfill certain conditions relating to vapor pressure, octane number, density and other parameters. The density is one of the parameters which are also established in the standards (for example EN 228). Possible manipulations of the stored fuel can be identified with the aid of a density measurement. The fuel density may for example be determined by a density measurement in conjunction with magnetostrictive filling level measurements, as described in the prior art (see U.S. Pat. No. 7,278,311 B1, US 2006/0266113 A1, US 2006/0169039 A1, U.S. Pat. No. 5,253,522, DE 10 2006 033 237 A1).

For some years, new gasoline fuels have been on the market, the properties of which are modified significantly by additions of ethanol or methanol. As before, these fuels must comply with the properties established in EN 228, including in particular a predetermined density range. However, because these fuels can sometimes take up much more water in solution than conventional gasoline fuels consisting of hydrocarbons, the density may vary significantly in the event of sizeable water concentrations. If the solubility limit is exceeded, not only does the water subsequently added separate out, but the alcohol dissolved in the fuel is also leached out with it. The density of the bottom-segregated phase, which accumulates in the lower region (sump region) of a storage tank, is therefore no longer about 1.0 g/m³ as in the case of water, but may be far less than this. This can have the effect that the separation layer floats hitherto used to detect water no longer float, and the operator of the filling station is no longer warned that there is a bottom-segregated phase, which provides an indication of a high water concentration in the fuel. Vehicles filled with such a fuel can stall or even be damaged.

In Germany, about 5% admixture of ethanol to gasoline fuel is prescribed in the biofuel ratio law (designation E05). A further increase of this proportion is under discussion. However, mixtures such as E20, E50 and E85 are also available on the market. In some other countries, methanol is also used for admixture. The behavior of these fuels in the event of water contamination differs greatly and leads to undetectable contamination situations with the risk of damage or breakdown of the motor vehicles filled with these liquids.

It is therefore an object of the invention to provide a method which makes it possible to detect hazardous contaminations with water even in fuels containing alcohol.

This object is achieved by a method for monitoring the quality of a fuel containing alcohol in a storage tank having the features of claim 1. Advantageous configurations of the invention are given by the dependent claims.

In the method according to the invention for monitoring the quality of a fuel containing alcohol in a storage tank, the density of the liquid present in the sump region of the storage tank is measured and compared with predetermined values, which characterize the density of a mixed phase containing water and alcohol as a function of its composition.

The sump region is the lower region of the storage tank. In general, the intake opening of the suction device, by means of which the fuel is pumped out of the storage tank, lies above the sump region.

Comparing the density value measured in the sump region with the predetermined values makes it possible to derive information about the properties of the fuel above the sump region, or entails interpretation or evaluation of these properties. For example, the composition of the fuel containing alcohol above the sump region can be estimated from the comparison between the measured density of the liquid in the sump region and the predetermined values. To this end the behavior of the initial fuel, i.e. the fuel containing alcohol which is initially not contaminated with water (and which contains at most a water admixture that cannot be separated from the alcohol), is taken into account in the event of contamination with water, which can lead to a defined density in a bottom-segregated phase of water and alcohol accumulating in the sump region. These properties are only partially known, and if necessary must be determined by experiments, in order to permit correct interpretation of the density values in the sump region and correct inferences about the fuel above the sump region.

In the previous paragraph, it was assumed that the mixed phase employed for the comparison is a bottom-segregated phase. This is the case for alcohol-containing fuels which cannot take up large amounts of water, so that phase separation takes place when a particular water concentration is exceeded and the excess water accumulates in the sump region of the storage tank while also taking up a proportion of alcohol.

It is, however, also conceivable that phase separation will not take place, so that a bottom-segregated phase will not accumulate in the sump region; rather, the mixed phase of water and alcohol present there also contains a large proportion of hydrocarbons and is representative of the overall content of the storage tank. In this case, conclusions about the fuel composition can also be drawn from a density measurement, here in the sump region, by comparison with predetermined values; in particular, the water concentration and the quality of the fuel in the storage tank can be evaluated.

In this context, gasoline fuels containing ethanol and gasoline fuels containing methanol behave very differently as a function of the alcohol and water content, as will be further explained in the examples given below.

In order to increase the accuracy of the method according to the invention, in preferred embodiments the temperature dependency of the density is taken into account. To this end, a temperature characteristic of the position of a density measurement can be measured at least at one point inside the storage tank, the comparison of measurement values for the density with predetermined values being carried out by taking the measured temperature into account.

To this end, for example, respective predetermined values employed for a comparison, which characterize the density of a mixed phase containing water and alcohol as a function of its composition, may be parameterized with the temperature, and the predetermined values which correspond to the measured temperature may be used for the comparison.

In advantageous embodiments of the invention, the density of the liquid present in the sump region of the storage tank is measured using a magnetostrictive density measurement device. Such a density measurement device is known, for example, from DE 10 2006 033 237 A1. It comprises a buoyant body, a spring engaging on the buoyant body, the elastic deformation of which is a measure of the upthrust force of the buoyant body, and a magnet arranged on the buoyant body. The elastic deformation of the spring is recorded by means of a magnetostrictive position measurement system. In the case of this device, the buoyant body lies fully in the liquid to be measured, the upthrust force which depends on the density of the liquid being measured so to speak by a spring balance. Preferably, the difference between the positions of the magnet and a fixed reference magnet along a measurement wire of the magnetostrictive position measurement system is used as a measure of the elastic deformation of the spring, which is to be determined.

As mentioned in the introduction, a storage tank for fuel often has an installed magnetostrictive filling level measurement system in which the position of a float, provided with a magnet and floating on the surface of the fuel, is recorded with the aid of a magnetostrictive position measurement system. In such a case, the magnetostrictive position measurement system that is provided can also be used for a density measurement in the sump region of the storage tank. This is because with a single magnetostrictive measurement wire and associated evaluation electronics, the positions of two and even more than two magnets along the measurement wire can be determined.

This also opens up the possibility of measuring the density of the fuel containing alcohol present in the storage tank above the sump region using a further magnetostrictive density measurement device, which also comprises a buoyant body, a spring engaging on the buoyant body, the elastic deformation of which is a measure of the upthrust force of the buoyant body, and a magnet arranged on the buoyant body. The elastic deformation of the spring is recorded by means of the same magnetostrictive position measurement system as is used for measuring the density of the liquid present in the sump region. The measurement values for the density of the fuel containing alcohol present in the storage tank above the sump region may likewise be compared with predetermined values, which characterize the density of a mixed phase of the alcohol-containing fuel with water as a function of the water concentration. In this way, measurement values can thus be obtained in the sump region and above it, which allows particularly comprehensive characterization of the properties of the fuel at the time of measurement.

The method according to the invention may be used for continuous monitoring of the fuel quality, if the density of the liquid present in the sump region of the storage tank is continuously measured and compared with the predetermined values (i.e. for example the density of a water/ethanol mixture or the density of a water/methanol mixture as a function of the water concentration). Preferably, logging is carried out by saving the measurement values. If the density of the fuel above the sump region is also measured, these values can be employed in a similar way for the monitoring. A signal characterizing the comparison result (which thus for example indicates that the measured density corresponds to a particular water concentration in the sump region) may for example be output via a digital interface to a report system. If the comparison result indicates the presence of a bottom-segregated phase, a warning signal is preferably generated.

As already mentioned, a bottom-segregated phase is not to be expected for all fuels containing alcohol in the event of water admixture. Even in this case, however, the result of the comparison of a density measurement in the sump region with predetermined values allows conclusions to be drawn about the current fuel quality, a signal characterizing the comparison result preferably being output via a digital interface to a report system, and a warning signal preferably being generated if the comparison result indicates the presence of water admixture to the fuel exceeding a predetermined limit value.

In the method according to the invention, the evaluation of the density data in the sump region provides the possibility not only of determining deviations in the product quality of the stored fuel, but also of diagnosing complex bottom-segregated phases which can occur with new types of fuels containing alcohol. The hitherto customary separation layer floats cannot be used for this, since they do not deliver quantitative density values but merely float when a predetermined density difference is exceeded; since the density in bottom-segregated phases is often significantly less than the density of water, with such separation layer floats the difference between the densities in the fuel and in the bottom-segregated phase would often even be insufficient to cause flotation.

The invention will be further explained below with the aid of exemplary embodiments. In the drawings:

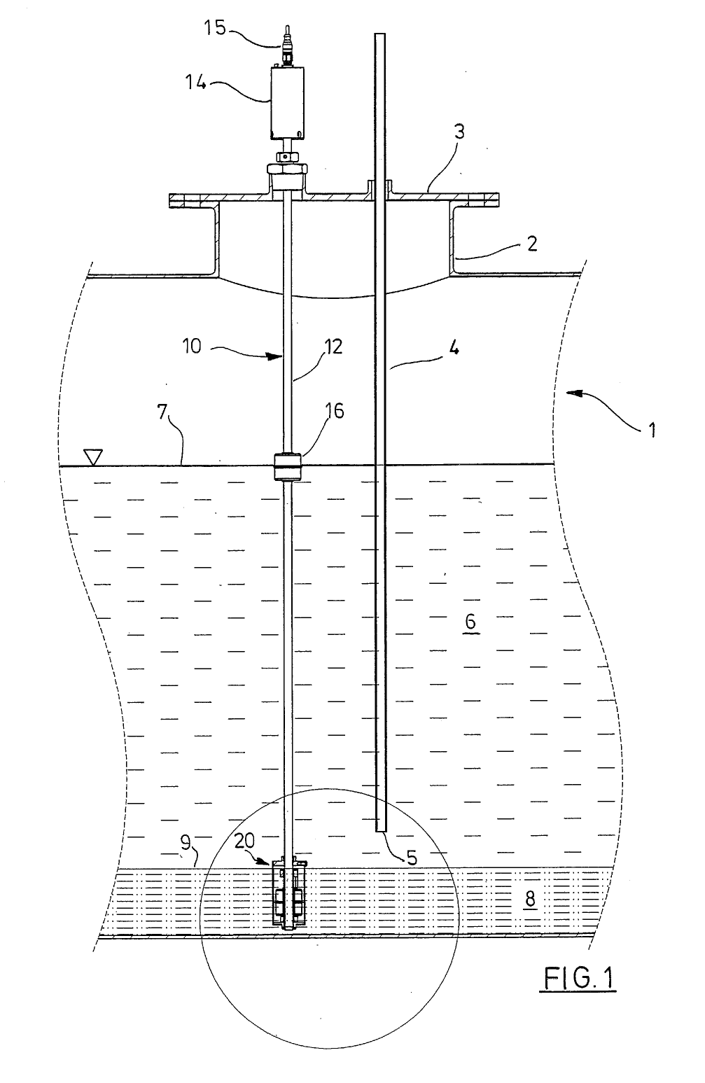

FIG. 1 shows a longitudinal section through a part of a storage tank for fuel having a magnetostrictive position measurement system for the filling level measurement, which carries a density measurement device used for carrying out the method according to the invention in the lower region, and

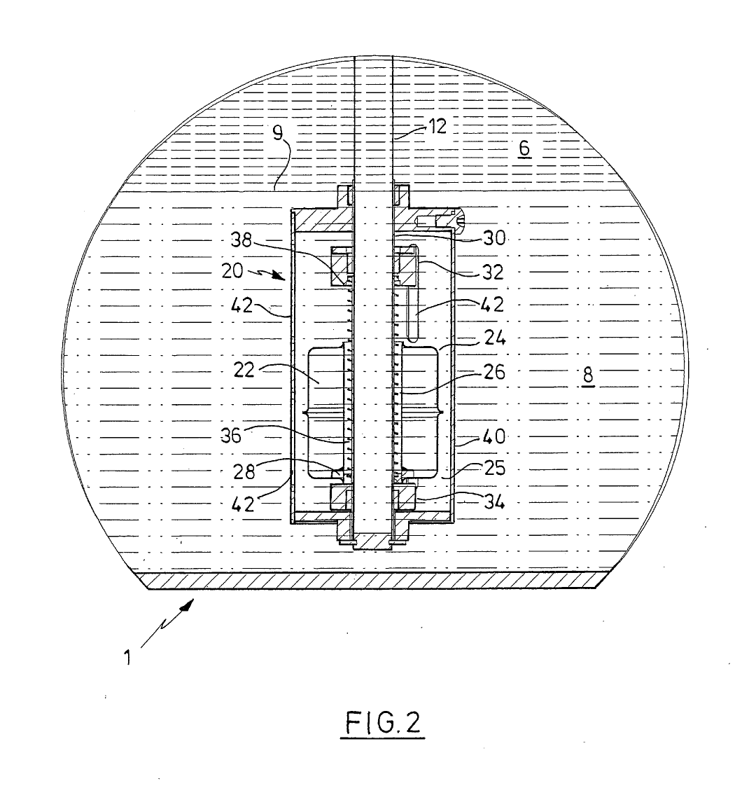

FIG. 2 shows an enlarged detail of FIG. 1 (with a somewhat modified filling level in the sump region of the storage tank), which shows the density measurement device in more detail.

FIG. 1 represents a subregion of a storage tank 1 for fuel in longitudinal section. The storage tank 1 has a dome 2 with a cover 3, through which a suction tube 4 having a lower end 5 is fed. The suction tube 4 is used to pump out the fuel 6, the filling level of which lies at 7. The lower end 5 of the suction tube 4 lies above a sump region 8 (level 9), so as not to take up any liquid from the sump region 8 during normal operation of the storage tank 1.

The storage tank 1 is equipped with a conventional magnetostrictive position measurement system 10 for the filling level measurement.

The position measurement system 10 has a protective tube 12, which reaches with its lower end almost as far as the bottom of the storage tank 1. Inside the protective tube 12, along its longitudinal axis, a measurement wire of the magnetostrictive position measurement system extends and is fed to an electronics unit 14. On its upper side, the electronics unit 14 contains a terminal 15 for attaching a signal cable, which can be connected to an external evaluation and control device.

Magnetostrictive measurement systems are known, as explained in the introduction. In these, a permanent magnet is used as a position pickup. Ultrasound waves are generated by the magnetostriction effect in a magnetostrictive waveguide, here the measurement wire contained in the protective tube 12. The time of flight of these ultrasound waves can be measured with high precision, to which end the electronics unit 14 is used here, so that the position of the permanent magnet can be determined reproducibly, for example to an accuracy of as much as 10 μm. It is also possible to measure a larger number of such magnetic position pickups on a magnetostrictive waveguide simultaneously, or almost simultaneously, a fact which is already used in a conventional configuration of a filling level and separation layer measurement system.

The filling level 7 of the fuel 6 is measured using a filling level float 16, which is guided on the protective tube 12 and floats on the surface of the fuel 6. Inside the filling level float 16, there is a permanent magnet with the aid of which, by means of the magnetostriction effect, it is possible to determine the position of the filling level float 16, and therefore the filling level in the storage tank 1.

The magnetostrictive position measurement system 10 is likewise used in order to be able to measure the density of the liquid in the sump region 8 of the storage tank 1. To this end, a density measurement device 20 is fitted on the protective tube 12 in the sump region 8.

The density measurement device 20, the principle of which is also described in detail in DE 10 2006 033 237 A1, is represented in an enlarged longitudinal section in FIG. 2.

A buoyant body 22 having an upper end 24 and a lower end 25, which is constructed with rotational symmetry about its longitudinal axis in the exemplary embodiment, has a cylindrical recess 26 along the longitudinal axis. In the vicinity of the lower end 25, the interior of the buoyant body 22 contains a magnet 28, which is a permanent magnet and is used as a position pickup in the magnetostrictive position measurement system 10.

The buoyant body 22 is mounted on a guide tube 30 so that it can be displaced longitudinally, and it can move between an upper end-stop 32 and a lower end-stop 34. The internal diameter of the guide tube 30 is slightly greater than the external diameter of the protective tube 12.

In the region of its lower end 25, the buoyant body 22 has an opening, the diameter of which is slightly greater than the external diameter of the guide tube 30 but less than the internal diameter of the recess 26, which is cylindrical in the exemplary embodiment. This forms an extension, on which a coil spring 36 can be supported by its lower end. The upper end of the coil spring 36 bears on the upper end-stop 32.

The upper end-stop 32 contains a reference magnet 38.

In the exemplary embodiment, the upthrust force of the buoyant body 22, when it is fully immersed in the liquid in the sump region 8 of the storage tank 1, is greater than its weight. The buoyant body 22 therefore moves upward away from the lower end-stop 34, but its further upward movement is opposed by the coil spring 36 which is then compressed. An equilibrium state is thus set up between the upthrust force on the one hand and the weight force plus the spring force on the other hand. The greater the density of the liquid is (more precisely, the greater its specific gravity is), the greater the upthrust force is, i.e. the coil spring 36 is compressed commensurately more. The equilibrium position of the buoyant body 22 can be determined with the aid of the magnetostrictive position measurement system 10 by means of the magnet 28 serving as a position pickup.

The density measurement device 20 is enclosed by a protective housing 40, which is fastened on the guide tube 30 and protects against liquid movements and contamination. So that the liquid can enter inside the protective housing 40, openings 42 are provided in the housing wall; in FIG. 2, two of these are represented in the longitudinal section and one (outside the plane of the paper) lying behind the upper end-stop 32. The guide tube 30 is fastened on the protective tube 12.

The reference magnet 38 may likewise be used as a position pickup in the magnetostrictive position measurement system 10. The density measurement device 20 can therefore be used without having to carry out calibration measurements for the absolute height of the magnet 28. The elastic deformation of the spring 36, which owing to the explained equilibrium is a measure of the density of the liquid in the sump region 8, is given by the difference between the positions of the magnet 28 and the reference magnet 38.

Since the magnetostrictive position measurement system 10 is capable of recording the positions of a plurality of magnets, a further density measurement device may be provided in the storage tank 1, above the sump region 8, so as also to record the density of the fuel 6. This density measurement device is preferably of the same design as the density measurement device 20, although fine tuning to the density range to be measured may be carried out by means of the buoyant body and/or the stiffness of the coil spring. The electronics unit 14 can be used for all the position measurements.

Temperature sensors are furthermore provided in the sump region 8 and above the level 9 in the storage tank 1, and are preferably arranged at the density measurement devices. The signal and supply lines of the temperature sensors may likewise be fed to the electronics unit 14.

The method according to the invention can be carried out with the aid of the measurement values obtained by the density measurement devices, as explained in the introduction. To this end, it is also possible to use external computers, which are connected by means of an interface to the terminal 15 of the electronics unit 14 and on which the measured density values are compared with the predetermined values and evaluated.

Two examples which further illustrate the procedure of the method are given below.

### EXAMPLE 1

In a gasoline fuel containing alcohol with an ethanol admixture to hydrocarbons, the solubility limit for water increases with an increasing ethanol content. If this limit is exceeded, a liquid segregates at the bottom of the storage tank (sump region), which contains water and some of the ethanol previously dissolved in the fuel. The density of this mixture (bottom-segregated phase) cannot be determined as a linear interpolation by means of the ratio of the initial volumes and the densities of water (about 1.0 g/cm³) and ethanol (about 0.79 g/cm³); rather, a shrinkage factor has to be taken into account, which may amount to as much as 4%. The density in the bottom-segregated phase increases with an increasing water component, so that the difference from the initial gasoline fuel (0.72 to 0.78 g/cm³) becomes increasingly large.

With the method according to the invention, even the small density difference between pure ethanol (which never occurs in practice since there is always a water component) and the upper density limit of the gasoline fuel can still be detected. In this case, the known temperature dependency of the densities of the liquids must be taken into account. The temperature value in the liquid can be delivered by means of a temperature sensor to the magnetostrictive filling level measurement system, which is used for the density measurement device.

The fuel quality stored in the storage container is saved in the evaluation system used for the method. The reliable density range to be expected and its temperature dependency are therefore known. In the case of gasoline fuels containing ethanol, with a small ethanol component (up to about 25%), a bottom-segregated phase due to water contamination can therefore be identified reliably.

With higher ethanol concentrations (>25%), the solubility for water increases greatly, that is to say a separate phase (bottom-segregated phase) is not formed. With an increasing water component, however, the density of the entire mixture increases, and therefore also does so in the sump region, so that water contamination can also be identified by a density measurement in the sump region.

### EXAMPLE 2

In the case of gasoline fuels containing methanol, the behavior in relation to water contamination is in part very different. With fairly small methanol concentrations (up about 20%), a methanol/water mixture likewise segregates, although the amount is much greater even with small water contamination. The leaching effect is thus significantly stronger. The bottom-segregated phases which occur can be detected by the method according to the invention.

With higher methanol concentrations, in contrast to ethanol mixtures a bottom-segregated phase occurs even with small water concentrations, and its density is close to the density of methanol. This phase may also still contain a proportion of hydrocarbons from the fuel. This phase can also be identified by the density measurement in the sump region. Higher water concentrations in this case likewise lead to an increase of the bottom-segregated phase and to a rise in its density.

1. A method for monitoring the quality of a fuel containing alcohol in a storage tank including a sump region, said method comprising the steps of:
measuring the density of the liquid present in the sump region of the storage tank; and
comparing the measured density with predetermined values to characterize the density of a mixed phase containing water and alcohol as a function of the composition of the mixed phase.

2. The method as claimed in claim 1,
said mixed phase being a bottom-segregated phase.

3. The method as claimed in claim 1; and
estimating the composition of the fuel containing alcohol above the sump region from the comparison between the measured density of the liquid in the sump region and the predetermined values.

4. The method as claimed in claim 1,
said measuring step including the step of using a magnetostrictive density measurement device comprising a buoyant body, a spring engaging the buoyant body, the elastic deformation of the spring being a measure of the upthrust force of the buoyant body, and a magnet disposed on the buoyant body, the elastic deformation of the spring being sensed by a magnetostrictive position measurement system.

5. The method as claimed in claim 4,
said measuring step further including the step of using a difference between positions of the magnet and a fixed reference magnet along a measurement wire of the magnetostrictive position measurement system as a measure of the elastic deformation of the spring.

6. The method as claimed in claim 4,
said fuel containing alcohol in the storage tank presenting a filling level,
said filling level being measured with the magnetostrictive position measurement system.

7. The method as claimed in claim claim 4; and
measuring the density of the fuel containing alcohol present in the storage tank above the sump region using a further magnetostrictive density measurement device comprising a buoyant body, a spring engaging the buoyant body, the elastic deformation of the spring being a measure of the upthrust force of the buoyant body, and a magnet disposed on the buoyant body, the elastic deformation of the spring being sensed by the same magnetostrictive position measurement system used for measuring the density of the liquid present in the sump region.

8. The method as claimed in claim 7; and
comparing the measurement values for the density of the fuel containing alcohol present in the storage tank above the sump region with predetermined values that characterize the density of a mixed phase of the alcohol-containing fuel with water as a function of the water concentration.

9. The method as claimed in claim 1; and
measuring a temperature characteristic of the position of a density measurement at least at one point inside the storage tank,
said comparing step of measurement values for the density with predetermined values including the step of taking the measured temperature into account.

10. The method as claimed in claim 9,
said comparing step further including the step of parameterizing respective predetermined values employed for a comparison with the temperature,
said predetermined values that correspond to the measured temperature being used for the comparison.

11. The method as claimed in claim 1,
said fuel comprising a gasoline fuel containing ethanol.

12. The method as claimed in claim 1,
said fuel comprising a gasoline fuel containing methanol.

13. The method as claimed in claim 1,
at least the density of the liquid present in the sump region of the storage tank being continuously measured and compared with the predetermined values.

14. The method as claimed in claim 2; and
outputting a signal characterizing the comparison result via a digital interface to a report system.

15. The method as claimed in claim 1; and
outputting a signal characterizing the comparison result via a digital interface to a report system.

16. The method as claimed in claim 14; and
generating a warning signal if the comparison result indicates the presence of a bottom-segregated phase.

17. The method as claimed in claim 15; and
generating a warning signal if the comparison result indicates the presence of water admixture to the fuel exceeding a predetermined limit value.
